(19) United States
(12) Patent Application Publication
(10) Pub. No.: US 2004/0228774 A1
(43) Pub. Date: Nov. 18, 2004

(54) Microreactor, its production method, and sample screening device

(75) Inventors: Taro Ogawa, Tokyo (JP); Masaru Izawa, Hino (JP); Nobuyuki Negishi, Kodaira (JP); Kaoru Umemura, Musashino (JP); Hiroshi Kakibayashi, Nagareyama (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 10/732,210

(22) Filed: Dec. 11, 2003

(30) Foreign Application Priority Data
May 12, 2003 (JP) 2003-132540

(51) Int. Cl. B01J 19/00

(52) U.S. Cl. 422/130

(57) ABSTRACT

Disclosed is a technology associated with a microreactor, which realizes convenient introduction of a sample biological cell such as an animal culture cell in the microcell, and enables further reduction in the size as well as higher integration of the microcells, thereby realizing a highly improved efficiency in the drug efficacy screening experiments. In the present invention, interior of the of the microreactor has been treated to impart higher affinity such as hydrophilicity for the sample such as cell while the surface near the microreactor has been treated to impart non-affinity such as water repellency. A mechanical vibration, oscillation, or shaking in either a defined pattern or in a random motion may be applied to the microreactor and the surface near the microreactor cavity by a motion generator or oscillator or the like. As a result, the cell or other sample that has been dropped near the microreactor can freely migrate along the surface without being adsorbed to the surface where it was first dropped, and the cell or other sample that has been once introduced in the interior of the microreactor will stay in the microreactor without moving out of the microreactor.

### PRIORITY CLAIM

This application claims priority under 35 USC 119 to Japanese patent application P2003-132540 filed May 12, 2003, the entire disclosure of which is hereby incorporated herein by reference.

### FIELD OF THE INVENTION

This invention relates to technologies associated with the so-called microreactor, which is a microcell structure for performing chemical reactions.

### BACKGROUND OF THE INVENTION

Development of new drugs is gaining momentum with the coming of the so called aging society and highly medical society, and with the completion of the human gene analysis. A new drug is brought into the commercial stage only after many steps such as drug discovery to find a candidate drug, development of a mass production process, and scale-up. An indispensable step in the drug discovery is the step of drug efficacy screening wherein candidate drugs are screened at the level of cells.

A typical process used in the drug efficacy screening of the new drug at the cell level is a process wherein cells of various types such as an animal cell culture or oocytes are introduced in a microcell structure called a “microreactor” into which the candidate drug substances are subsequently introduced (for example, see Patent Document 1, Japanese Patent Laid-Open No. 2001-330604). In such a process, if a cell is sensitive to the candidate drug substance, the cell will exhibit an increase or a decrease in cell membrane potential, morphological change such as cell division, color development by fluorochrome, or the like. Sensitivity of the cell for the candidate drug substance, namely, the drug efficacy can be determined by detecting such indication.

In a recent proposal, attempts have been made to arrange a large number of microcells in the form of a matrix to thereby improve the throughput of the screening (for example, see Patent Document 2, Japanese Patent Laid-Open No. H10-337173).

As proposed in the Patent Document 2 as mentioned above, the cell structure has been produced, for example, by using crystal silicon for the matrix, and forming the cell structure by anisotropic etching after masking the surface area which should remain unetched.

The conventional system as described above is capable of realizing a high throughput drug efficacy screening, namely, the so called “high throughput screening”. However, a critical constituent technology for realizing such high throughput screening is the technology associated with the microcell structure, namely, the so called “microreactor” where a cell is introduced.

Conventional microreactors, however, suffer from a problem that introduction of the cell and stable maintenance of the cell in the microcell is difficult when the cell used is not an oocyte with spherical shape and the size of millimeter order but an animal cell which is amorphous with the size of the order of 10 microns. The conventional system thus needs to correspond to a drug efficacy screening experiments of higher reliability wherein animal cell culture can be screened.

The present invention has been completed in view of the situation as described above, and this invention provides a technology associated with a microreactor wherein the sample such as an animal culture cell can be readily introduced in the microcell, and wherein further reduction in the size and higher integration of the microcells are enabled to thereby enable remarkable improvements in the efficiency of the drug efficacy screening experiments and the like.

In order to achieve the above, the microreactor of the present invention has a unique feature that surfaces of various parts of the microreactor have been treated by different treatments to exhibit different polarity from the sample.

To be more specific, in the microreactor of the present invention, an inner surface of the cavity (concave surface) has an affinity for the cell and other samples which is higher than that of the surface of the substrate. Additionally, in the microreactor of the present invention, the inner surface of the cavity has been treated to impart an affinity such as hydrophilicity for the sample while the surface near the microreactor cavity has been treated to impart a non-affinity such as water repellency. The present invention has also enabled to apply mechanical, vibration, oscillation, or shaking in either a defined pattern or in a random motion to the microreactor and the surface near the microreactor by using a suitable motion generator or oscillator or the like.

As a result of such unique features, the cell or other sample that has been dropped near the microreactor can freely migrate along the surface and into the microreactor without being adsorbed to the surface where it was first dropped, and the cell or other sample that has been introduced in the microreactor will be captured in the microreactor without moving out of the microreactor. Accordingly, the cell can be maintained within the microreactor in a stable manner even if the sample used were an amorphous, extremely small animal cell with the size in the order of about 10 microns. Reduction in the size as well as increase in the integrity of the microreactor is thereby enabled to realize highly improved efficiency of the drug efficacy screening experiments and other sample screening processes.

### BRIEF DESCRIPTION OF THE DRAWINGS

FIG. 1 is a cross sectional view for explaining the concept of the microreactor according to the present invention;

FIG. 2 is a view showing the process steps for producing the microreactor according to the first embodiment of the present invention;

FIG. 3 is a view showing the process steps for producing the microreactor according to the second embodiment of the present invention;

FIG. 4 is a view showing the process steps for producing the microreactor according to the third embodiment of the present invention;

FIG. 5 is a view showing typical microreactor structures formed by the process steps shown in FIG. 4;

FIG. 6 is a view showing the process steps for producing the microreactor according to the fourth embodiment of the present invention;

FIG. 7 is a view showing typical measurement steps wherein membrane potential of the test cell for the candidate drug substance is measured by the microreactor of the present invention for the purpose of drug efficacy screening;

FIG. 8 is a view showing an exemplary plate wherein microreactor microcells are arranged in the form of a 4×4 matrix; and

FIG. 9 is a view showing a typical construction of the apparatus wherein a series of automated drug efficacy screening steps are carried out.

### DETAILED DESCRIPTION OF THE INVENTION

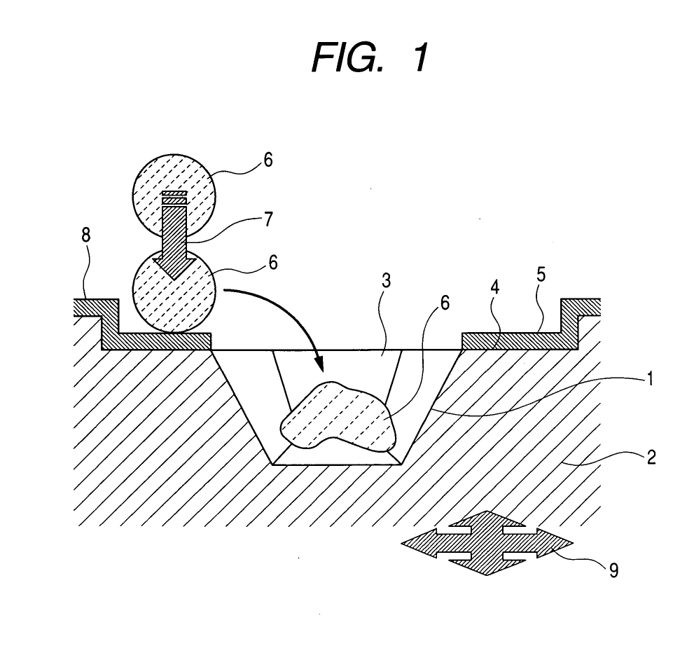

FIG. 1 is a view for explaining the concept (basic constitution) of the microreactor according to the present invention.

In FIG. 1, 1 represents a microreactor having a microcell structure, 2 represents a substrate of the microreactor, 3 represents inner surface (concave surface) of cavities defined in the microreactor, 4 represents surface near the microreactor, 5 represents a layer or surface-treated layer formed near the microreactor exhibiting non-affinity for cell 6, 6 represents a test cell, 7 is an arrow indicating dripping of the test cell, 8 represents the grid separating test cell cavities from each other, 9 is an arrow indicating the mechanical vibration, oscillation, or shaking in either a defined pattern or in a random motion of the microreactor produced by a suitable motion generator or oscillator.

In FIG. 1, the cell 6 dropped on the surface 4 near the microreactor 1 will become adsorbed on the surface if the surface 4 near the microreactor 1 has affinity for the cell 6 and introduction of the cell 6 into the cell into the microreactor 1 will be difficult. In contrast, when the surface 4 near the microreactor 1 is provided with a layer or a surface treatment 5 so that this area exhibit non-affinity for the cell 6, the cell 6 will be able to migrate along the surface without being adsorbed into the surface of this area, and such migration can be facilitated by the vibration, oscillation, or shaking in either a defined pattern or in a random motion of the microreactor 1 and the substrate 2 as indicated by the arrow 9. In addition, the cell 6 that has been introduced in the microreactor 1 will be trapped in the microreactor 1 and will not move out of the microreactor 1 when the interior 3 of the microreactor 3 has an affinity for the cell 6. Accordingly, the cell will be maintained within the microreactor in a stable manner even if the test cell 6 used were an amorphous, extremely small animal cell with the size in the order of about 10 microns. Reduction in the size as well as an increase in the integrity of the microreactor are thereby enabled to realize highly improved efficiency of the drug efficacy screening experiments and other sample screening processes.

It is to be noted that, in FIG. 1, the microreactor may be constituted so that the substrate is provided with a grid 8 to prevent migration of the cell 6 between adjacent microreactor cavities.

The term “affinity”, as used herein, designates affinity as exemplified by the contact angle with water of approximately 20 to 30 degrees or adsorption of cells and proteins as typically found in glass surface, and the term “non-affinity”, as used herein, designates water repellency as exemplified by the contact angle with water of approximately at least 90 degrees or non-adsorption of cells and proteins as typically found in polymer surface.

Next, typical embodiments of the present invention are described.

(1) A microreactor comprising a substrate having a plurality of cavities defined on its surface, wherein each cavity has a concave surface for receiving samples, and said concave surface is imparted with an affinity for the introduced sample which is higher than the affinity of the surface of said substrate for the same sample.

(2) A microreactor comprising a substrate having a cavity defined on its surface for receiving a sample to enable a predetermined chemical reaction to take place in the cavity, wherein inner surface of the cavity is imparted with an affinity for the sample, and the surface of the substrate near the cavity is imparted with a non-affinity for the sample.

(3) The microreactor as described above wherein said cavity has a concave surface, which has been treated to impart hydrophilicity or adsorption capacity for cells and proteins.

(4) The microreactor as described above wherein said surface of the substrate near the cavity has been treated to impart water repellency or non-adsorption capacity for cells and proteins.

(5) A microreactor comprising a substrate having a plurality of cavities defined on its surface, wherein each cavity has a concave surface for receiving samples; an electrode formed in each of said concave surface of said cavity; a heater formed in the interior of said substrate; a temperature controller for controlling temperature of said heater; a plurality of first current terminals for measuring the current flowing through said electrodes; a second current terminal for supplying current to said heater; and a connector for connecting said first current terminal and said second current terminal; wherein said concave surface of said cavity is imparted with the affinity for the introduced sample which is higher than affinity of the surface of said substrate for the same sample.

(6) A sample screening device comprising a microreactor comprising a substrate having a plurality of cavities defined on its surface for receiving a first sample; an introducer for introducing a second sample to said microreactor; a measurement means for measuring ion current or fluorescent characteristics of said first sample which has been introduced in said microreactor; and a suitable motion generator or oscillator for vibration, oscillation, or shaking in either a defined pattern or in a random motion said microreactor; wherein said concave surfaces of said cavities are imparted with an affinity for the introduced first sample which is higher than the affinity of the surface of said substrate for the same first sample.

(7) A method for producing a microreactor comprising a substrate having a cavity defined on its surface to enable a predetermined chemical reaction to take place in the cavity, comprising the steps of: treating inner surface of said cavity to impart said surface with hydrophilicity or adsorption capacity for cells and proteins; and treating the surface of said substrate other than the cavities to impart said surface with water repellency or non-adsorption capacity for cells and proteins.

Next, Examples of the present invention are described with reference to the drawings. These examples are not limiting or a complete description of the entire invention as a whole, but merely show certain features which may be part of the invention.

### EXAMPLE 1

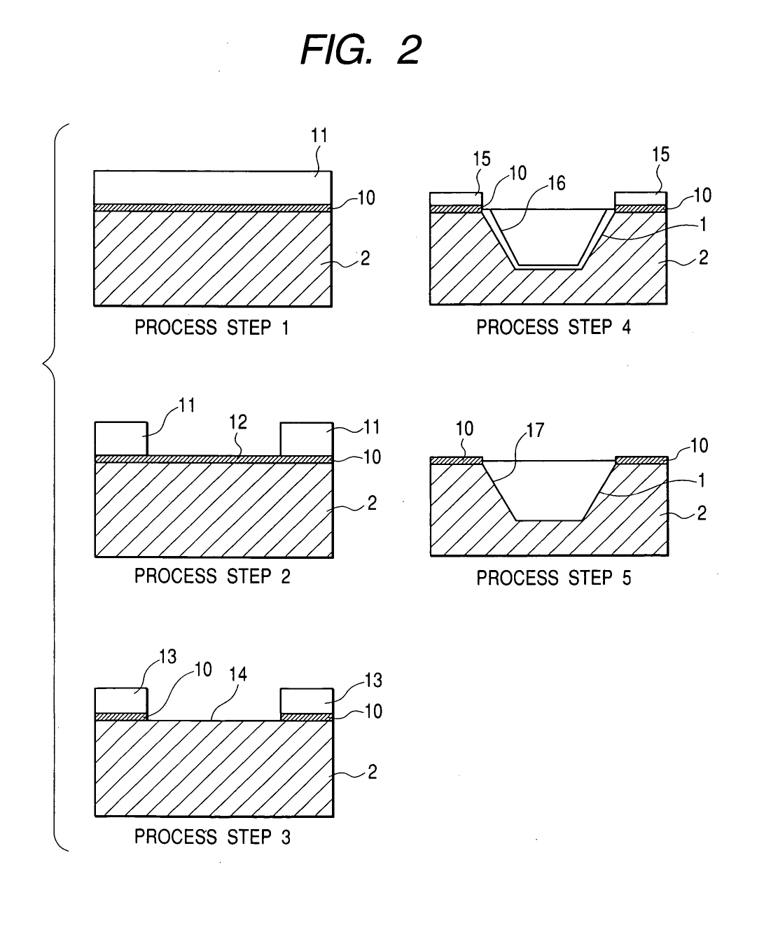

FIG. 2 is a view showing process steps for producing the microreactor structure according to the first embodiment of the present invention. In FIG. 2, 10 represents a fluorocarbon layer that has been deposited, 11 represents a resist layer, 12 represents an opening formed in the resist layer 11, 13 represents the resist layer whose thickness has been reduced by plasma dry etching, 14 represents the opening formed in the resist layer 13 and the fluorocarbon layer 10, 15 represents the resist layer whose thickness has been reduced by plasma dry etching, 16 represents the thin film that has been deposited on the side wall of the microreactor 1, and 17 represents a surface of glass that became exposed after removing the thin film.

As shown in process step 1, tetracarbon hexafluoride (C₄F₆) gas at a pressure of 1 Pascal (Pa) to 10 Pa was formed into a plasma in the high frequency range at a frequency of 450 MHz and a power of 1000 W, and a microreactor substrate 2 comprising a glass material such as quartz was exposed to this C₄F₆ gas plasma atmosphere to deposit a fluorocarbon layer (polymerized layer) 10 having a thickness of 2 μm. It is to be noted that the fluorocarbon layer 10 could be imparted with an improved density and coating by controlling the substrate temperature or by controlling the components of ion irradiation by applying substrate bias. On the fluorocarbon layer 10 was further formed a negative resist layer 11 for ultraviolet light (UV) for example at a wavelength of 365 nm to a thickness of 10 μm by coating and baking.

Next, as shown in process step 2, a 50 μm square region near the microreactor cavity was exposed to ultraviolet light (UV) with an ultraviolet light (UV) exposure system, and developed to form an opening 12 of 50 μm square.

Next, as shown in process step 3, oxygen (O₂) gas at a pressure of 1 Pa to 10 Pa was formed into a plasma in the high frequency range at a frequency of 450 MHz and a power of 1000 W, and the opening 12 was exposed to the plasma atmosphere of O₂ gas to thereby remove the polymerized film 10 under the opening 12 by dry etching and form an opening 14 of 50 μm square.

Next, as shown in process step 4, a gas mixture of C₄F₆, O₂, and argon (Ar) was formed into plasma in the high frequency range at a frequency 450 MHz and a power of 1000 W, and a microreactor 1 was formed by removing the substrate 2 under the opening 14 by plasma dry etching using the resist layer 13 for the etching mask.

Next, as shown in process step 5, oxygen gas at a pressure of 1 Pa to 10 Pa was formed into a plasma in the high frequency range at a frequency of 450 MHz and a power of 1000 W, and the resist layer 15 was exposed to the plasma atmosphere of O₂ gas to thereby remove the resist layer and simultaneously remove the thin film 16 on the glass surface 17 and expose the glass surface 17. As a consequence, the surface near the microreactor cell became water repellent while the interior of the microreactor cell became hydrophilic, and trapping of the test cell was thereby facilitated.

It is to be noted that, while C₄F₆ gas was employed in this Example for depositing the fluorocarbon layer and etching the glass substrate with plasma, equivalent effects could be achieved by other fluorocarbon gas represented by the general formula CₓF_{y} such as CF₄, C₃F₆, C₄F₈, or C₆F₈; by a hydrofluorocarbon gas represented by general formula CₓF_{y} such as CHF₃ and CH₂F₂; by a hydrofluorocarbon gas represented by the general formula CₓH_{y}F_{z}; or by a mixture of such gas with a rare gas such as helium (He), Ar, krypton (Kr), or xenon (Xe). In addition, O₂ gas could be added to such gas to thereby simultaneously etch and remove the deposited layer to thereby facilitate control of the deposited layer thickness.

Furthermore, while plasma polymerization was employed in this Example to deposit water repellent fluorocarbon layer on the substrate, layers performing equivalent function could be formed by other methods, for example, by applying a fluorine varnish or a mixture of fluororesin fine particles with titanium oxide fine particles, or the like. The substrate 2 comprising silicon, glass, or the like could also be imparted with water repellency by exposure to plasma, heat, or other atmosphere for nitriding of its surface.

It is also to be noted, although the concave surface which has been treated to impart hydrophilicity or adsorption capacity for proteins and the surface which has been treated to impart water repellency or non-adsorption capacity for proteins were provided in this Example by forming a single layer or film, such surface could of course comprise two or more layers or films. This equally applies to other Examples as described below.

### EXAMPLE 2

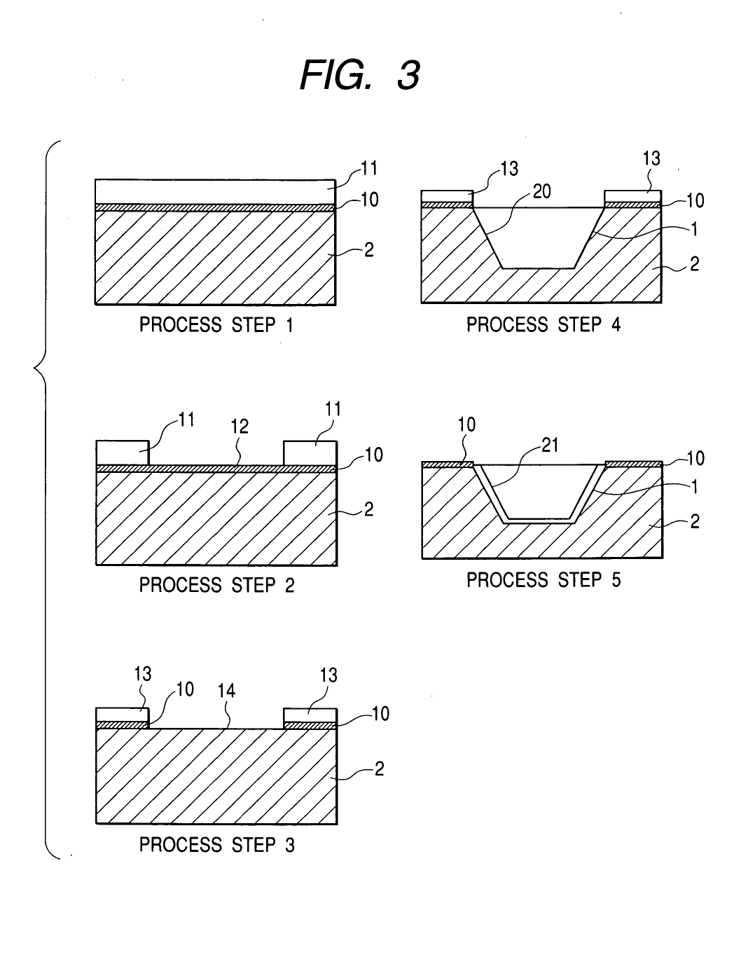

FIG. 3 is a view showing process steps for producing the microreactor structure according to the second embodiment of the present invention. In FIG. 3, 20 represents exposed (111) surface of Si, and 21 represents (111) surface of Si which has been oxidized into SiO₂ by plasma.

First, as shown in process step 1, C₄F₆ gas at a pressure of 1 Pa to 10 Pa was formed into a plasma in the high frequency range at a frequency of 450 MHz and a power of 1000 W, and the microreactor substrate 2 comprising single crystal Si having the crystal direction (100) exposed to its surface was exposed to this C₄F₆ gas plasma atmosphere to deposit a fluorocarbon layer 10 having a thickness of 2 μm. It is to be noted that the polymerized layer 10 could be imparted with an improved density, adhesion, and coating by controlling the substrate temperature or by controlling the components of ion irradiation by applying substrate bias On the fluorocarbon layer 10 was further formed a negative resist layer 11 for ultraviolet light (UV) to a thickness of 10 μm by coating and baking.

Next, as shown in process step 2, a 50 μm square region near the microreactor cavity was exposed to ultraviolet light (UV) with an ultraviolet light (UV) exposure system, and developed to form an opening 12 of 50 μm square. It is to be noted, that the edges of the square of the opening 12 was consistent with the (110) direction of Si.

Next, as shown in process step 3, O₂ gas at a pressure of 1 Pa to 10 Pa was formed into a plasma in the high frequency range at a frequency of 450 MHz and a power of 1000 W, and the substrate 2 was exposed to the plasma atmosphere of O₂ gas to thereby remove the polymerized film 10 under the opening 12 by dry etching with plasma and form an opening 14 of 50 μm square.

Next, as shown in process step 4, the substrate 2 under the opening 14 was removed by anisotropic wet etching using aqueous solution of potassium hydroxide (KOH) and aqueous solution of tetramethylammonium hydride (TMAH) to form the microreactor 1 wherein (111) surface 20 of Si is exposed to its surface.

Next, as shown in process step 5, oxygen gas at a pressure of 1 Pa to 10 Pa was formed into a plasma in the high frequency range at a frequency of 450 MHz and a power of 1000 W, and the substrate 2 was exposed to the plasma atmosphere of O₂ gas to thereby remove the remaining resist layer 13 and oxidize the exposed (111) surface 20 of Si into SiO₂ surface 21. As a consequence, the surface near the microreactor cell became water repellent while the interior of the microreactor cell became hydrophilic, and trapping of the test cell was thereby facilitated.

It is to be noted that, while C₄F₆ gas was employed in this Example for depositing the fluorocarbon layer, equivalent effects could be achieved by other fluorocarbon gas represented by the general formula CₓF_{y} such as CF₄, C₃F₆, C₄F₈, or C₆F₈; by a hydrofluorocarbon gas represented by general formula CₓF_{y} such as CHF₃ and CH₂F₂; by a hydrofluorocarbon gas represented by the general formula CₓH_{y}F_{z}; or by a mixture of such gas with a rare gas such as He, Ar, Kr, or Xe. In addition, O₂ gas could be added to such gas to thereby simultaneously etch and remove the deposited layer to thereby facilitate control of the deposited layer thickness.

Furthermore, while plasma polymerization was employed in this Example to deposit water repellent fluorocarbon layer on the substrate, layers performing equivalent function could be formed by other methods, for example, by applying a fluorine varnish or a mixture of fluororesin fine particles with titanium oxide fine particles, or the like. In addition, while the microreactor structure was formed by plasma etching, the microreactor structure could also be formed by other method, for example, by dry etching using focused ion beam.

### EXAMPLE 3

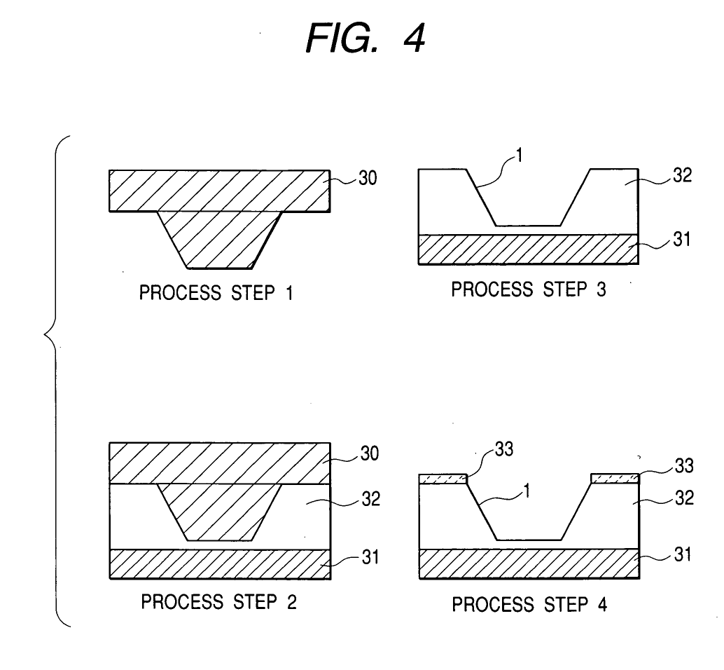

FIG. 4 is a view showing process steps for producing the microreactor structure according to the third embodiment of the present invention. In FIG. 4, 30 represents a mold for the microreactor comprising Si which had been formed by plasma dry etching or wet etching, 31 represents an underlying substrate, 32 represents polydimethylsiloxane (PDMS) polymer which had been coated on the underlying substrate 31, and 33 represents 2-methacryloyloxyethyl phosphorylcholine (MPC) polymer which has been coated around the PDMS microreactor 1 after releasing the mold.

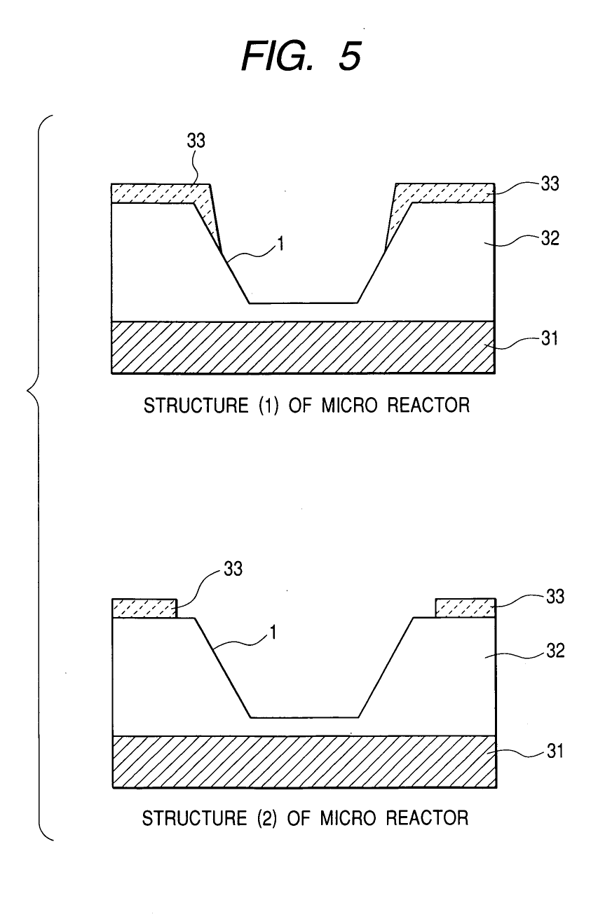

FIG. 5 shows other embodiments of the microreactor structure produced by the process steps shown in FIG. 4.

As shown in process steps 1 to 3 of FIG. 4, the mold 30 was pressed onto the PDMS polymer 32 having a thickness of 20 μm which had been coated on the underlying substrate 31, and after baking, the mold 30 was released. The microreactor 1 comprising PDMS polymer was thereby formed.

Next, as shown in process step 4, a solution of MPC polymer in a solvent was selectively coated near the microreactor 1 by using a nozzle, and the coating was baked to form the MPC polymer layer 33.

It was then found that, when the test cell used was a blood cell, coagulation of the blood cell dropped near the microreactor was prevented, and the blood cell could be easily introduced to the interior of the microreactor.

It is to be noted that, while the microreactor was formed by using PDMS polymer in this Example, an equivalent microreactor structure could be formed when other polymer, for example, polyethylene terephthalate or polymethyl methacrylate was used. Adsorption of the blood cell could be equivalently prevented when the MPC polymer layer was formed near the microreactor in the microreactor structure described in Examples 1 and 2 comprising quartz or other glass, Si, or other material.

In addition, the MPC polymer coating layer may be provided to partly cover the interior of the microreactor 1 as shown in microreactor structure (1) of FIG. 5, or to partly cover the surface 4 near the microreactor 1 as shown in microreactor structure (2) of FIG. 5 according to the ease of introducing the blood cell into the interior of the microreactor.

### EXAMPLE 4

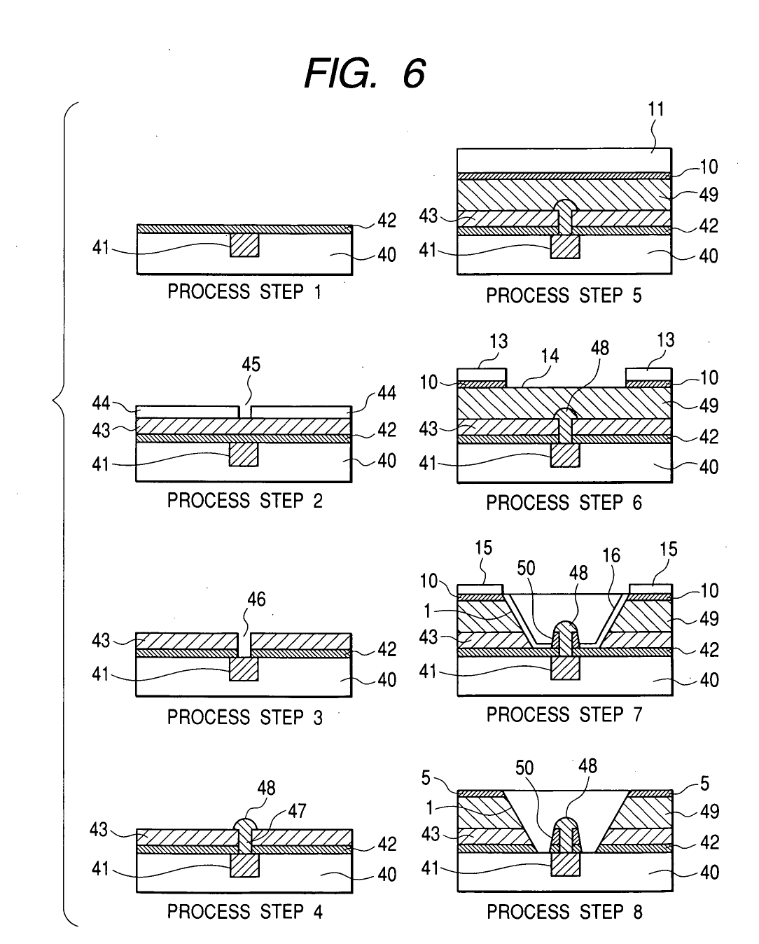

FIG. 6 is a view showing process steps for producing the microreactor structure according to the fourth embodiment of the present invention. In FIG. 6, 40 represents a substrate comprising a SiO₂ insulation layer, 41 represents a wire embedded in the substrate 40, 42 represents a silicon nitride (SiN) etch stop layer formed on the substrate 40, 43 represents SiO₂ insulation layer formed on the etch stop layer 42, 44 represents a resist layer formed on the SiO₂ insulation layer 43, 45 represents a circular resist opening formed in alignment with the wire 41, 46 represents a through hole formed through the insulation layer and the etch stop layer, 47 represents a metal embedded in the through hole 45, 48 represents protrusion which extends from the metal, 49 represents an insulation layer formed on the insulation layer 43 and the metal protrusion 48, and 50 represents the insulation layer remaining around the metal portion. The metal 47 and its protrusion 48 constitute an electrode.

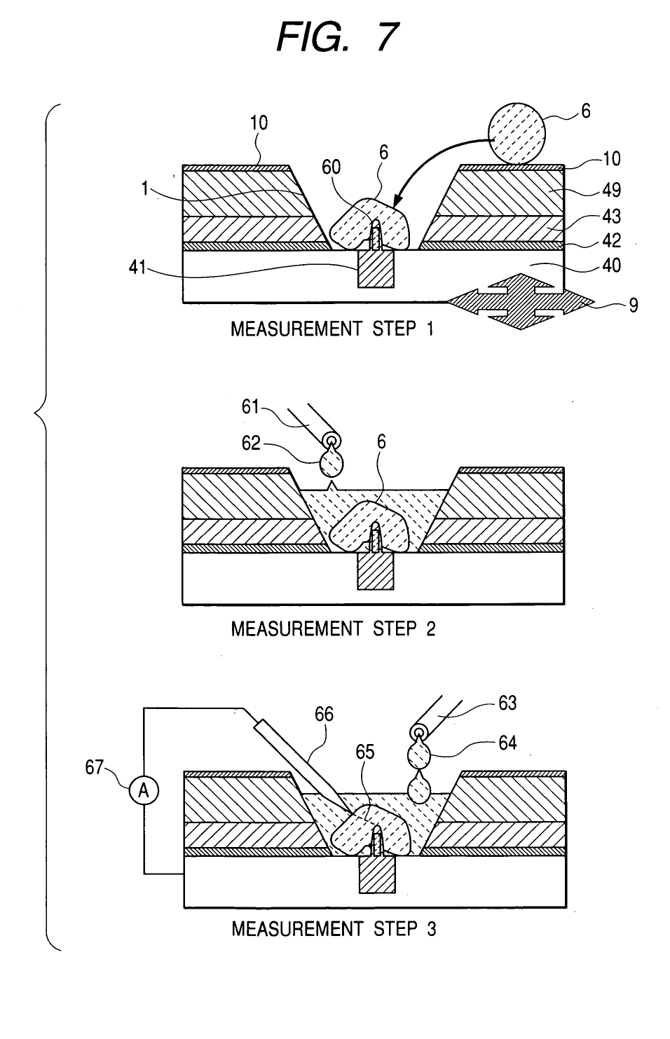

FIG. 7 is a schematic view showing measurement steps wherein membrane potential of the test cell for the candidate drug substance is measured by using the microreactor of the present invention for the purpose of drug efficacy screening. In FIG. 7, 60 represents a probe, 61 represents a nozzle for introducing a culture medium for the cell, 62 represents the cell culture medium, 63 represents a nozzle for introducing the drug solution, 64 represents the drug solution, 65 indicates ion current flowing through cell membrane, 66 represents a probe, and 67 represents an ammeter.

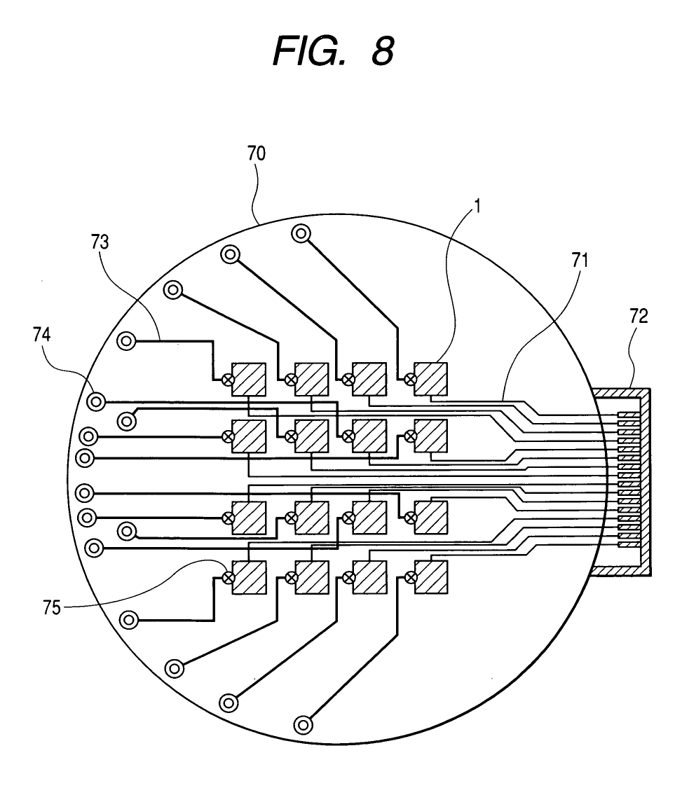

FIG. 8 is a schematic view showing a substrate wherein microreactor microcells are arranged in the form of a 4×4 matrix. In FIG. 8, 70 represents a substrate (plate) on which microcells are arranged, 71 represents a wire embedded in 70 which is connected to the probe in the microreactor 1, 72 represents a connector, 73 represents a micro-flow channel formed in the substrate for carrying the drug solution to the microreactor, 74 represents an inlet for introducing the drug solution, and 75 represents a microvalve provided in the micro-flow channel.

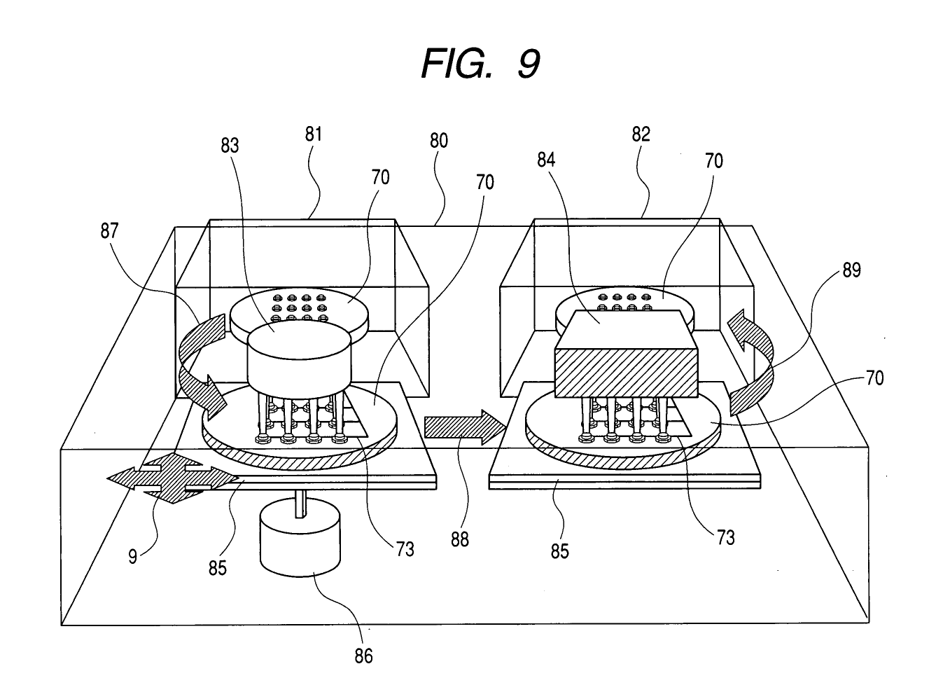

FIG. 9 is a view showing a typical construction of the apparatus wherein a series of automated steps of drug efficacy screening or sample screening are carried out. In FIG. 9, 80 represents the main body of the measuring apparatus, 81 represents an entrance for the substrates, 82 represents an exit for the substrate, 83 represents a dropper for the sample biological cell, 84 represents an injector for the drug solution (or probe unit), 85 represents a substrate stage, 86 represents a suitable motion generator or oscillator, and 87, 88, and 89 indicates transportation actions, respectively.

First, as shown in process step 1 of FIG. 6, the wire 41 having a width of 3 μm was formed in the substrate 40 by the steps of depositing tantalum nitride (TaN) seed metal by photolithography, dry etching, or sputtering, embedding copper (Cu) by electroplating, and chemical mechanical polishing.

Next, as shown in process step 2, source gas was dissociated at a high frequency of 13.56 MHz, and a SiN etch stop layer 42 having a thickness of 0.5 μm and a SiO₂ insulation layer 43 having a thickness of 5 μm were deposited by plasma CVD wherein the reaction took place on the substrate surface. The source gas used for the SiN layer was a gas mixture of silane (SiH₄) and ammonia (NH₃), and the source gas used for SiO₂ layer was tetraethylorthosilicate [Si(OC₂H₅)₄, TEOS] gas. On the insulation layer 43 was further formed a negative resist layer 44 for ultraviolet light (UV) having a thickness of 1 μm by coating and baking, and a circular region with a diameter of 1 μm was exposed to ultraviolet light (UV) with an ultraviolet light (UV) exposure system and developed to form a resist opening 45 having a diameter of 1 μm.

Next, as shown in process step 3, a gas mixture of C₄F₆ and Ar at a pressure of 1 Pa to 10 Pa was formed into a plasma in the high frequency range at a frequency of 450 MHz and a power of 1000 W, and the SiO₂ insulation layer 43 under the resist opening 45 was removed by plasma dry etching. A gas mixture of CHF₃ and Ar at a pressure of 1 Pa to 10 Pa was formed into a plasma in the high frequency range at a frequency of 450 MHz and a power of 1000 W, and the SiN etch stop layer 42 was removed. Furthermore, oxygen gas at a pressure of 1 Pa to 10 Pa was formed into a plasma in the high frequency range at a frequency of 450 MHz and a power of 1000 W, and the resist layer 44 was exposed to the plasma atmosphere of O₂ gas for its removal and formation of the through hole 46.

Next, as shown in process step 4, after dipping the piece in the anode side of gold (Au) plating solution, current was passed through the wire 41 to precipitate Au in the through hole 46 to thereby embed Au 47 in the through hole 46. An excessive current was then applied to form the metal protrusion 48 of Au having a diameter of 3 μm on the Au 47.

Next, as shown in process step 5, a SiO₂ insulation layer 49 having a thickness of 10 μm was formed on the SiO₂ insulation layer 43 and the metal protrusion 48 by dissociating the source gas at a high frequency of 13.56 MHz and conducing plasma CVD wherein the reaction took place on the substrate surface. The source gas used for the SiO₂ insulation layer was TEOS gas. C₄F₆ gas at a pressure of 1 Pa to 10 Pa was then formed into a plasma in the high frequency range at a frequency of 450 MHz and a power of 1000 W, and the SiO₂ insulation layer 49 was exposed to the plasma atmosphere of C₄F₆ gas to deposit a fluorocarbon layer 10 having a thickness of 2 μm. It is to be noted that the fluorocarbon layer 10 could be imparted with an improved density and coating by controlling the substrate temperature or by controlling the components of ion irradiation by applying substrate bias. On the fluorocarbon layer 10 was further formed a negative resist layer 11 for ultraviolet light (UV) to a thickness of 10 μm by coating and baking.

Next, as shown in process step 6, the 20 μm square region near the microreactor cavity was exposed to ultraviolet light (UV) with an ultraviolet light (UV) exposure system to form a 20 μm square resist opening. Then, oxygen gas at a pressure of 1 Pa to 10 Pa was formed into a plasma in the high frequency range at a frequency of 450 MHz and a power of 1000 W, and the resist opening was exposed to the plasma atmosphere of O₂ gas to remove the fluorocarbon layer 10 by plasma dry etching and form a 20 μm square resist opening 14.

Next, as shown in process step 7, a gas mixture of C₄F₆ and Ar at a pressure of 1 Pa to 10 Pa was formed into a plasma in the high frequency range at a frequency of 450 MHz and a power of 1000 W, and the SiO₂ insulation layers 49 and 43 under the resist opening 14 were removed by plasma dry etching to form the microreactor 1. Since the portion under the metal protrusion 48 remained unetched in this step, this part of the insulation layer remained as remainder 50.

Next, as shown in process step 8, a gas mixture of CHF₃ and Ar at a pressure of 1 Pa to 10 Pa was formed into a plasma in the high frequency range at a frequency of 450 MHz and a power of 1000 W, and the SiN etch stop layer 42 at the bottom of the microreactor 1 was removed. Furthermore, oxygen gas at a pressure of 1 Pa to 10 Pa was formed into a plasma in the high frequency range at a frequency of 450 MHz and a power of 1000 W, and the microreactor 1 was exposed to the plasma atmosphere of O₂ gas to thereby remove the remaining resist layer 15 simultaneously with the thin film 16 on the side wall of the microreactor and expose the SiO₂ surface. As a consequence, a microreactor structure provided with a probe at its bottom was formed.

It is to be noted that, while the wire 41 was formed from Cu, and the metal 47 embedded in the through hole 45 and the metal protrusion 48 was formed by Au plating in this Example, similar structure could be produced by forming the wire 41 from a metal other than Cu such as aluminum or aluminum alloy, and the metal 47 embedded in the through hole 45 and the metal protrusion 48 from tungsten by CVD or the like.

Alternatively, the SiN etch stop layer 42 may be left unremoved in the process step 8 so that the side wall and the bottom of the microreactor 1 exhibits different affinity for the sample biological cell cell.

Next, candidate drug substances were screened for their drug efficacy by measuring cell membrane potential using the microreactor produced by this process. This screening is described by referring to FIG. 7.

First, as shown in the measurement step 1, a cell 6 having a size of about 10 μm was dropped near the microreactor 1 while vibration, oscillation, or shaking in either a defined pattern or in a random motion the substrate as indicated by the arrow 9 at a horizontal displacement of 1 μM, a vertical displacement of 1 μm, and a frequency of 100 Hz. The fluorocarbon layer 10 then prevented adsorption of the cell 6 to the upper surface of the microreactor, and the cell 10 smoothly migrated along the microreactor upper surface due to the vibration, oscillation, or shaking in either a defined pattern or in a random motion indicated by arrow 9. Also, the cell 8 that had been once trapped in the microreactor 1 remained in the microreactor 1 without exiting the microreactor 1 after introduction of the probe 60 owing to the hydrophilicity of the inner wall of the microreactor.

Next, as shown in the measurement step 2, the culture medium 62 for the cell was introduced from a nozzle 61 into the interior of the microreactor 1. The cell culture medium 62 could then be introduced in a stable manner due to the hydrophilicity of the inner wall.

Next, as shown in the measurement step 3, a probe 66 was introduced in the cell membrane of the cell 8, and a drug solution 64 containing the candidate drug substance was introduced dropwise. Effects induced by the drug solution in the receptor of the cell membrane of the test cell 8 were then monitored in terms of ion current 65 with an ammeter. 67, and a high throughput drug efficacy screening of the candidate drug substances was thereby realized.

It is to be noted that, while only one probe 60 was provided at the bottom of the microreactor 1, the probe 60 could be provided at an increased number, and at a position different from the bottom of the microreactor 1 as desired. If desired, it is also possible to provide a substrate 40 comprising SiO₂ insulation layer, or a heater, a Peltier element, a temperature sensor, and the like which are required for controlling the environment of the microreactor 1 in the interior of the SiO₂ insulation layers 43 and 49.

It is also to be noted that, while a structure including the probe 60 was provided in this Example for measuring the ion current 65, it was also possible to provide a through hole in the bottom of the microreactor 1 for aspiration of the cell 8 thereto to thereby measure the ion current 65 by utilizing a solution filled in the through hole. The drug efficacy could also be determined by the process other than measuring the ion current 65, for example, by measuring fluorescent/luminescent characters, or by microscopic observation of the morphological changes of the cell such as those brought by cell division.

FIG. 8 schematically shows the substrate wherein microcells have been arranged in the form of a 4×4 matrix. In FIG. 8, a plurality of microreactors 1 are arranged on the substrate (plate) 70, and the culture medium for the cell, the drug solution, and other solutions that are necessary in the drug efficacy screening are introduced from the inlet 74. Then, the solution will be supplied to the microreactors 1 at required amounts through the micro-flow channels 73 and the microvalves 75 formed in the plate 70, and the ion current from the probe formed in the microreactor 1 will be taken out to the exterior through the wire 71 embedded in the plate 70 and the connector 72 attached to the plate 70. A parallel measurement of a large number of microreactors is then enabled, and drug efficacy screening of the candidate drug substances could be accomplished at a higher speed.

In the foregoing, an embodiment wherein microcells are arranged in the form of a 4×4 matrix has been described by referring to FIG. 8. The present invention, however, is not limited to such an embodiment, and includes any embodiment wherein a plurality of microcells are arranged in a two dimensional arrangement or in the form of a matrix.

FIG. 9 shows a typical constitution of the apparatus wherein an automated series of steps for drug efficacy screening, sample screening, or the like are carried out.

The measurement plate 70 was introduced from an entrance 81 and carried onto a stage 85 as indicated by the arrow 87, and the motion generator or oscillator 86 was actuated to shake the stage 1 and the plate 70 as shown by the arrow 9. The test cell could be then being introduced in the microreactor by dropping the test cell onto the plate 70 near the microreactor 1 with a dropper 83. Next, the plate 70 was carried to a position immediately under the probe unit 84 as indicated by the arrow 88. Culture medium for the test cell was then introduced into the microreactor through micro-flow channels 73 formed in the plate 70, and the probe was introduced into the cell in the microreactor cell by the descending probe unit 84. Next, the drug solution was introduced into the plate 70 through micro-flow channels 73.

The ion current flowing between the wire 71 embedded in the plate 70 and the corresponding probe of the probe unit 84 could then be measured. The plate 70 which had completed its measurement was carried out of the apparatus from an exit 82 as indicated by the arrow 89 simultaneously with the introduction of a new plate 70 from the entrance, and the drug efficacy screening of the candidate drug substances could be continuously accomplished.

In this system, the test cell was introduced into the microreactor by dropping the test cell onto the plate 70. The test cell, however, could also be selectively introduced in the microreactor by selective cell cultivation utilizing the difference in the polarity, affinity, or water repellency of the surfaces of the plate 70. It was also possible to combine the present system with a cell cultivation system to preliminarily prepare a plate 70 wherein the test cell was attached only to the interior of the microreactor, and subsequently carrying the plate 70 to the screening apparatus wherein the drug efficacy screening was carried out.

As described above, this invention has enabled an easy and stable introduction of the cells into the minute microreactor cell, and hence, reduction in the cell size as well as increase in the degree of cell integration are enabled. A microreactor which can be used in a high throughput drug efficacy screening is thereby provided.

Also disclosed is a sample screening device comprising a microreactor for receiving sample biological cells comprising a substrate having a plurality of cavities defined on its surface for receiving a first sample biological cell; an introducer for introducing a second sample biological cell to said microreactor; a measurement means for measuring ion current or fluorescent characteristics of said first sample biological cell which has been introduced in said microreactor; and a motion generator or oscillator for vibration, oscillation, or shaking in either a defined pattern or in a random motion said microreactor; wherein concave surfaces of said cavities are imparted with a first affinity for the introduced first sample biological cell which is higher than a second affinity of the surface of said substrate for the first sample biological cell.

The sample screening device may include an introducer for introducing the second sample biological cell to said microreactor comprises an introducer for introducing the second sample biological cell to said concave surface of said cavities.

The sample screening device may further comprise a controller for controlling the amount of said second sample biological cell introduced.

The sample screening device may further comprise at least one heater for heating said microreactor; and a temperature controller for controlling temperature of said microreactor.

Also disclosed is a method for producing a microreactor comprising a substrate having a cavity defined on its surface to enable a predetermined chemical reaction to take place in the cavity, comprising: forming in a substrate at least one cavity;

treating an inner surface of said cavity to impart said surface with hydrophilicity or adsorption capacity for cells and proteins, and treating the surface of said substrate other than the cavities to impart said surface with water repellency or non-adsorption capacity for cells and proteins.

The method may also impart hydrophilicity or adsorption capacity for cells and proteins and comprises: treating said inner surface of said cavity with plasma by using at least one gas selected from the group consisting of a fluorocarbon gas represented by the formula CₓF_{y} a hydrofluorocarbon gas represented by the formula CₓH_{y}F_{z}, or a mixture of said CₓF_{y} or CₓH_{y}F_{z} with a rare gas, to form a treated surface of the substrate.

The method may also include producing a microreactor wherein said step of imparting water repellency or non-adsorption capacity for cells and proteins comprises providing at least a film selected from the group consisting of a fluorocarbon film, a fluorine varnish film, a mixture of a fluororesin or microparticles of titanium oxide on the surface of said substrate, other than on the cavities, to form a surface on said substrate covered with such film.

The method may also include producing a microreactor wherein the substrate is formed of glass or silicon.

The method may also include the treated surface of the cavity becoming SiO₂.

The method may also include the feature that the treated surface of the cavity becomes amorphous glass or crystallized glass.

What is claimed is:

1. A microreactor comprising a substrate having a plurality of cavities defined on its surface for receiving an introduced sample biological cell, wherein
each cavity has a concave surface for receiving samples, and
said concave surface is imparted with a first affinity for the introduced sample biological cell which is higher than a second affinity of a surface of said substrate for the sample biological cell.

2. A microreactor for receiving a sample biological cell comprising:
a substrate having a surface and a cavity defined on its surface for receiving the sample biological cell to enable a predetermined chemical reaction to take place in the cavity, wherein an inner surface of the cavity is imparted with an affinity for the sample biological cell, and the surface adjoining the cavity is imparted with a non-affinity for the sample biological cell.

3. A microreactor according to claim 1 wherein said cavity has a concave surface which has been treated to impart hydrophilicity or adsorption capacity for cells and proteins.

4. A microreactor according to claim 1 wherein said surface of the substrate adjoining the cavity has been treated to impart water repellency or non-adsorption capacity for cells and proteins.

5. A microreactor according to claim 3 wherein:
said concave surface which has been treated to impart hydrophilicity or adsorption capacity for cells and proteins comprises a glass substrate or a silicon substrate which has been treated with plasma by using at least one gas selected from the group consisting of a fluorocarbon gas represented by the formula CₓF_{y}, a hydrofluorocarbon gas represented by the formula CₓH_{y}F_{z}, and a mixture of said CₓF_{y} or CₓH_{y}F_{z} with a rare gas.

6. A microreactor according to claim 4 wherein:
said surface of the substrate adjoining the cavity which has been treated to impart water repellency or non-adsorption capacity for cells and proteins comprises at least a film formed on said surface of the substrate, said film being selected from the group consisting of a fluorocarbon film, a fluorine varnish film, or a mixture of a fluororesin and microparticles of titanium oxide.

7. A microreactor according to claim 4 wherein said surface of said substrate adjoining the cavity which has been treated to impart water repellency or non-adsorption capacity for cells and proteins comprises a layer formed from at least one material selected from polydimethylsiloxane polymer films, polyethylene terephthalate films, and polymethyl methacrylate films.

8. A microreactor according to claim 1 wherein said cavities are arranged in the form of a matrix on said substrate.

9. A microreactor according to claim 1 wherein each of said plurality of cavities is provided with an electrode in each concave surface.

10. A microreactor according to claim 9 wherein said electrode is in the form of a protrusion.

11. A microreactor according to claim 9 further comprising a connector for supplying current to said electrode, and a wire connecting said connector and said electrode.

12. A microreactor according to claim 11 wherein said wire is formed in the interior of said substrate.

13. A microreactor according to claim 1 further comprising a heater and a temperature sensor formed in the interior of said substrate.

14. A microreactor according to claim 13 further comprising a current terminal for supplying current to said heater and said temperature sensor.

15. A microreactor according to claim 1 further comprising a grid formed on said substrate for preventing migration of said sample biological cell between adjacent cavities.

16. A microreactor comprising a substrate having a plurality of cavities defined on its surface, wherein each cavity has a concave surface for receiving at least one sample biological cell; an electrode formed in each of said concave surface of said cavity; a heater formed in the interior of said substrate; a temperature controller for controlling temperature of said heater; a plurality of first current terminals for measuring the current flowing through said electrodes; a second current terminal for supplying current to said heater; and a connector for connecting said first current terminal and said second current terminal; wherein said concave surface of said cavity is imparted with a first affinity for the introduced sample biological cell which is higher than a second affinity of the surface of said substrate for the same sample biological cell.

17. A microreactor according to claim 16 further comprising a flow channel for introducing the sample biological cell into the interior of said concave surface of said cavities; and a sample inlet formed at an end of said flow channel.

18. The microreactor of claim 1 wherein the biological cell samples are approximately 10 to 20 microns in size.
